(19) United States
(12) Patent Application Publication
(10) Pub. No.: US 2026/0006525 A1
(43) Pub. Date: Jan. 1, 2026

(54) Inter-Donor Full Migration of Mobile Integrated Access and Backhaul Nodes

(71) Applicant: Apple Inc., Cupertino, CA (US)

(72) Inventors: Peng Cheng, Beijing (CN); Naveen Kumar R Palle Venkata, San Diego, CA (US); Haijing Hu, Los Gatos, CA (US); Ralf Rossbach, Munich (DE); Alexander Sirotkin, Hod Hasharon (IL)

(21) Appl. No.: 18/994,224

(22) PCT Filed: Jul. 15, 2022
(86) PCT No.: PCT/CN2022/105935

§ 371 Date: Jan. 14, 2025

(51) Int. Cl. H04W 36/36; H04W 36/00; H04W 36/08

(52) U.S. Cl. CPC H04W 36/362; H04W 36/0055; H04W 36/00837; H04W 36/087

(57) ABSTRACT

This disclosure relates to techniques for performing inter-donor full migration of mobile integrated access and backhaul nodes in a wireless communication system. An integrated access and backhaul node may perform mobile termination migration from a source donor centralized unit to a target donor centralized unit. The node may also perform distributed unit migration from the source donor centralized unit to the target donor centralized unit. Handover from the source donor centralized unit to the target donor centralized unit may be configured for one or more wireless devices served by the distributed unit of the integrated access and backhaul node.

### FIELD

The present application relates to wireless communications, and more particularly to systems, apparatuses, and methods for performing inter-donor full migration of mobile integrated access and backhaul nodes in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1xRTT, 1xEV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for performing inter-donor full migration of mobile integrated access and backhaul nodes in a wireless communication system.

According to the techniques described herein, in addition to mobile termination migration for an integrated access and backhaul node, distributed unit migration for the integrated access and backhaul node can also be performed, to accomplish inter-donor full migration of the integrated access and backhaul node. These techniques may allow an integrated access and backhaul node to be fully served by a different donor after the migration is performed than before the migration is performed, which can be used by a cellular network to more effectively perform load balancing between various network elements of the cellular network, at least according to some embodiments.

In conjunction with such full integrated access and backhaul node migration, techniques are also described for performing group handover of wireless device served by an integrated access and backhaul node that performs inter-donor full migration. The group handover can be accomplished using basic or conditional handover approaches. Basic handover, if used, can be initiated before or after the inter-donor full migration is performed. Multiple trigger conditions are possible for a conditional handover approach, potentially including any or all of a handover notification-based trigger, or a cell identifier change-based trigger, among various possibilities.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a flowchart diagram illustrating aspects of an exemplary possible method for performing inter-donor full migration of mobile integrated access and backhaul nodes in a wireless communication system, according to some embodiments;

FIG. 6 illustrates aspects of a system in which inter-donor partial migration can be performed, according to some embodiments;

FIGS. 7A-7B illustrate a signal flow diagram showing a possible procedure for inter-donor partial migration, according to some embodiments;

FIG. 8 illustrates aspects of a system in which inter-donor full migration can be performed, according to some embodiments;

FIG. 9 is a signal flow diagram illustrating a possible procedure for performing a switch from a source donor CU to a target donor CU for a IAB boundary node DU, according to some embodiments;

FIG. 10 is a signal flow diagram illustrating possible aspects of a basic handover approach to performing group handover of wireless devices served by an IAB node that is initiated before the IAB node performs inter-donor full migration, according to some embodiments;

FIG. 11 is a signal flow diagram illustrating possible aspects of a basic handover approach to performing group handover of wireless devices served by an IAB node that is initiated after the IAB node performs inter-donor full migration, according to some embodiments;

FIG. 12 is a signal flow diagram illustrating possible aspects of a conditional handover approach to performing group handover of wireless devices served by a migrating IAB node using a handover notification trigger condition, according to some embodiments; and

FIG. 13 is a signal flow diagram illustrating possible aspects of a conditional handover approach to performing group handover of wireless devices served by a migrating IAB node using a PCI or NCGI change trigger condition, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology
TRP: Transmission-Reception-Point
DCI: Downlink Control Information
CORESET: Control Resource Set
QCL: Quasi-Co-Located or Quasi-Co-Location
CSI: Channel State Information
CSI-RS: Channel State Information Reference Signals
CSI-IM: Channel State Information Interference Management
CMR: Channel Measurement Resource
IMR: Interference Measurement Resource
ZP: Zero Power
NZP: Non Zero Power
CQI: Channel Quality Indicator
PMI: Precoding Matrix Indicator
RI: Rank Indicator

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

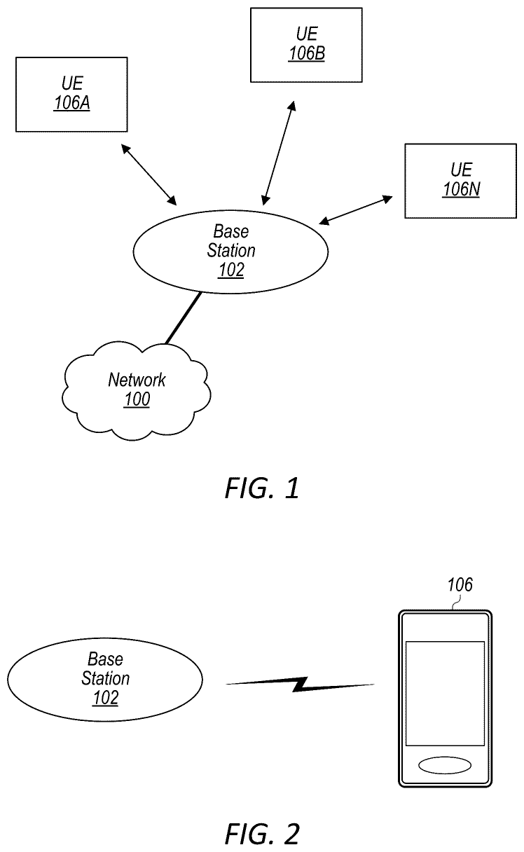

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

Note that, at least in some 3GPP NR contexts, base station (gNB) functionality can be split between a centralized unit (CU) and a distributed unit (DU). The illustrated base station 102 may support the functionality of either or both of a CU or a DU, in such a network deployment context, at least according to some embodiments. In some instances, the base station 102 may be configured to act as an integrated access and backhaul (IAB) donor (e.g., including IAB donor CU and/or IAB donor DU functionality). In some instances, the base station 102 may be configured to act as an IAB node (e.g., including IAB mobile termination (MT) and IAB-DU functionality). Other implementations are also possible.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1xRTT, 1xEV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques related to inter-donor full migration of mobile integrated access and backhaul nodes in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any

combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1xRTT (or LTE or NR, or LTE or GSM), and separate radios for communicating using each of Wi-Fi and BLUETOOTH™. Other configurations are also possible.

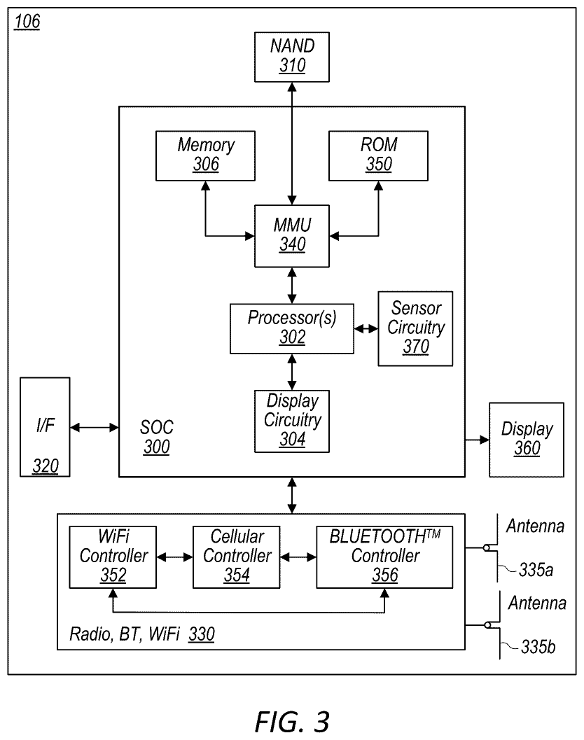

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform techniques related to inter-donor full migration of mobile integrated access and backhaul nodes in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques related to inter-donor full migration of mobile integrated access and backhaul nodes in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

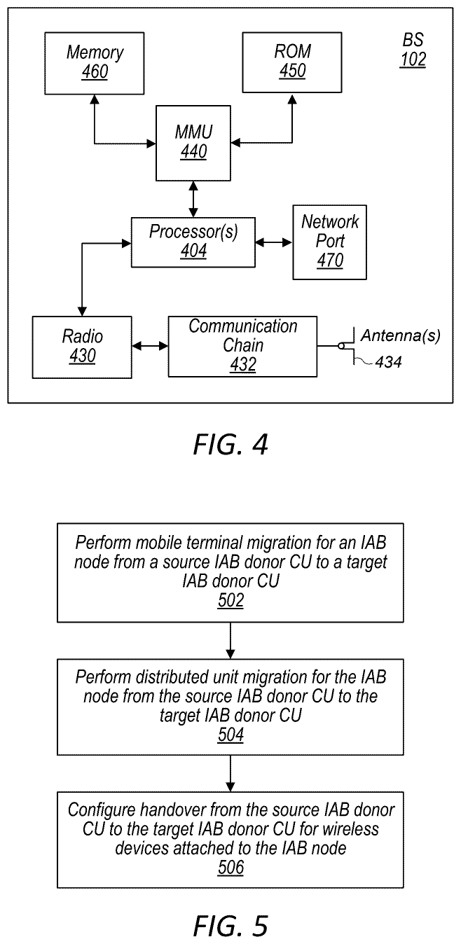

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### Reference Signals

A wireless device, such as a user equipment, may be configured to perform a variety of tasks that include the use of reference signals (RS) provided by one or more cellular base stations. For example, initial access and beam measurement by a wireless device may be performed based at least in part on synchronization signal blocks (SSBs) provided by one or more cells provided by one or more cellular base stations within communicative range of the wireless device. Another type of reference signal commonly provided in a cellular communication system may include channel state information (CSI) RS. Various types of CSI-RS may be provided for tracking (e.g., for time and frequency offset tracking), beam management (e.g., with repetition configured, to assist with determining one or more beams to use for uplink and/or downlink communication), and/or channel measurement (e.g., CSI-RS configured in a resource set for measuring the quality of the downlink channel and reporting information related to this quality measurement to the base station), among various possibilities. For example, in the case of CSI-RS for CSI acquisition, the UE may periodically perform channel measurements and send channel state information (CSI) to a BS. The base station can then receive and use this channel state information to determine an adjustment of various parameters during communication with the wireless device. In particular, the BS may use the received channel state information to adjust the coding of its downlink transmissions to improve downlink channel quality.

In many cellular communication systems, the base station may transmit some or all such reference signals (or pilot signals), such as SSB and/or CSI-RS, on a periodic basis. In some instances, aperiodic reference signals (e.g., for aperiodic CSI reporting) may also or alternatively be provided.

As a detailed example, in the 3GPP NR cellular communication standard, the channel state information fed back from the UE based on CSI-RS for CSI acquisition may include one or more of a channel quality indicator (CQI), a precoding matrix indicator (PMI), a rank indicator (RI), a CSI-RS Resource Indicator (CRI), a SSBRI (SS/PBCH Resource Block Indicator, and a Layer Indicator (LI), at least according to some embodiments.

The channel quality information may be provided to the base station for link adaptation, e.g., for providing guidance as to which modulation & coding scheme (MCS) the base station should use when it transmits data. For example, when the downlink channel communication quality between the base station and the UE is determined to be high, the UE may feed back a high CQI value, which may cause the base station to transmit data using a relatively high modulation order and/or a low channel coding rate. As another example, when the downlink channel communication quality between the base station and the UE is determined to be low, the UE may feed back a low CQI value, which may cause the base station to transmit data using a relatively low modulation order and/or a high channel coding rate.

PMI feedback may include preferred precoding matrix information, and may be provided to a base station in order to indicate which MIMO precoding scheme the base station should use. In other words, the UE may measure the quality of a downlink MIMO channel between the base station and the UE, based on a pilot signal received on the channel, and may recommend, through PMI feedback, which MIMO precoding is desired to be applied by the base station. In some cellular systems, the PMI configuration is expressed in matrix form, which provides for linear MIMO precoding. The base station and the UE may share a codebook composed of multiple precoding matrixes, where each MIMO precoding matrix in the codebook may have a unique index. Accordingly, as part of the channel state information fed back by the UE, the PMI may include an index (or possibly multiple indices) corresponding to the most preferred MIMO precoding matrix (or matrixes) in the codebook. This may enable the UE to minimize the amount of feedback information. Thus, the PMI may indicate which precoding matrix from a codebook should be used for transmissions to the UE, at least according to some embodiments.

The rank indicator information (RI feedback) may indicate a number of transmission layers that the UE determines can be supported by the channel, e.g., when the base station and the UE have multiple antennas, which may enable multi-layer transmission through spatial multiplexing. The RI and the PMI may collectively allow the base station to know which precoding needs to be applied to which layer, e.g., depending on the number of transmission layers.

In some cellular systems, a PMI codebook is defined depending on the number of transmission layers. In other words, for R-layer transmission, N number of Nₜ×R matrixes may be defined (e.g., where R represents the number of layers, Nₜ represents the number of transmitter antenna ports, and N represents the size of the codebook). In such a scenario, the number of transmission layers (R) may conform to a rank value of the precoding matrix (Nₜ×R matrix), and hence in this context R may be referred to as the “rank indicator (RI)”.

Thus, the channel state information may include an allocated rank (e.g., a rank indicator or RI). For example, a MIMO-capable UE communicating with a BS may include four receiver chains, e.g., may include four antennas. The BS may also include four or more antennas to enable MIMO communication (e.g., 4×4 MIMO). Thus, the UE may be capable of receiving up to four (or more) signals (e.g., layers) from the BS concurrently. Layer to antenna mapping may be applied, e.g., each layer may be mapped to any number of antenna ports (e.g., antennas). Each antenna port may send and/or receive information associated with one or more layers. The rank may include multiple bits and may indicate the number of signals that the BS may send to the UE in an upcoming time period (e.g., during an upcoming transmission time interval or TTI). For example, an indication of rank 4 may indicate that the BS will send 4 signals to the UE. As one possibility, the RI may be two bits in length (e.g., since two bits are sufficient to distinguish 4 different rank values). Note that other numbers and/or configurations of antennas (e.g., at either or both of the UE or the BS) and/or other numbers of data layers are also possible, according to various embodiments.

### FIG. 5—Inter-donor Full Migration of Mobile Integrated Access and Backhaul Nodes

Cellular network architecture can include support for functional splitting of cellular base stations. For example, in 5G NR, it may be possible for a gNB to be functionally split between a logical centralized unit (CU) and a logical distributed unit (DU). Further, it may be possible that a CU can be associated with multiple DUs, at least in some instances. The CU and DU may provide support for different protocol stack layers; for example, the CU could provide support for higher layers such as service data adaptation protocol (SDAP), packet data convergence protocol (PDCP), radio resource control (RRC), etc, while the DU could provide support for lower layers such as radio link control (RLC), media access control (MAC), physical (PHY), etc. The interface between the CU and the DU in a 3GPP network may be referred to as the F1 interface, at least according to some embodiments.

In a network deployment scenario with fixed (e.g., wired) backhaul connections, the relationship (association) between a CU and a DU may generally be relatively fixed. However, with the development of support for integrated access and backhaul (IAB) nodes, which may be able to establish backhaul connections via a wireless physical interface, more flexible associations between CUs and DUs may be possible. An IAB node may include a DU and a mobile termination (MT) entity, and may be capable of establishing NR-based wireless backhaul with an IAB “donor”, which may itself include a CU and a (e.g., wire-connected) DU, possibly via one or more intermediary IAB nodes. Thus, for example, it may be feasible for an IAB node that provides DU functionality to “migrate,” e.g., including changing from being associated with one donor CU to being associated with a different donor CU. Providing support for such migration may allow for a network to perform load balancing more dynamically, for example by providing the option to migrate an IAB node DU from being associated with a more heavily loaded donor CU to instead be associated with a more lightly loaded donor CU. However, in order for full IAB node migration to be performed, it may be necessary to provide signaling frameworks for accomplishing the migration/handover of the IAB-MT, the IAB-DU, and any wireless devices served by the IAB-DU from a “source” donor CU to a “target” donor CU.

Thus, it may be beneficial to specify techniques for performing inter-donor full migration of mobile integrated access and backhaul nodes. To illustrate one such set of possible techniques, FIG. 5 is a flowchart diagram illustrating a method for performing inter-donor full migration of mobile integrated access and backhaul nodes in a wireless communication system, at least according to some embodiments.

Aspects of the method of FIG. 5 may be implemented by one or more cellular base stations (e.g., IAB nodes and/or IAB donors), e.g., in conjunction with one or more wireless devices, such as a BS 102 and a UE 106 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

The wireless device may establish a wireless link with a cellular base station. According to some embodiments, the wireless link may include a cellular link according to 5G NR. For example, the wireless device may establish a session with an AMF entity of the cellular network by way of one or more gNBs that provide radio access to the cellular network. As another possibility, the wireless link may include a cellular link according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology (e.g., UMTS, CDMA2000, GSM, etc.), according to various embodiments.

Establishing the wireless link may include establishing a RRC connection with a serving cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least in some instances, establishing the wireless link(s) may include the wireless device providing capability information for the wireless device. Such capability information may include information relating to any of a variety of types of wireless device capabilities.

The serving cell for the wireless device may be provided by way of a DU provided by an IAB node, which may be associated with an IAB donor CU. A backhaul path between the IAB-DU and the IAB donor CU may at least include an IAB donor DU (e.g., that is associated with the IAB donor CU), and possibly also one or more intermediary IAB nodes.

In 502, the IAB node may perform mobile termination (MT) migration from its current (“source”) IAB donor CU to a new (“target”) IAB donor CU. The MT migration may also be referred to as partial migration, in some instances. In some instances, this may include performing handover of the IAB-MT from a source parent node (which may be the source IAB donor DU or an intermediary IAB node) to a target parent node (which may be the target IAB donor DU or an intermediary IAB node), where the source and target parent nodes are served by different IAB donor CUs (e.g., where the source parent node is served by the source IAB donor CU and the target parent node is served by the target IAB donor CU). For example, the source IAB donor CU may provide a handover request to the target IAB donor CU, the source and target IAB donor CUs may transfer context information for the migrating IAB-MT, and the migrating IAB-MT may perform a random access (RACH) procedure with the target parent node to establish the physical interface between the nodes. Note that after the partial migration of the IAB-MT to connect to the target IAB donor CU, the IAB-DU of the migrating IAB node may retain its FI connection with the source IAB donor CU, e.g., with a modified path including the newly established wireless physical interface between the IAB-MT and the target parent node, as well as any other intermediary nodes (if applicable) along the path between the IAB-MT and the target IAB donor DU.

In 504, the IAB node may perform DU migration from the source IAB donor CU to the target IAB donor CU. The IAB-DU migration may include setting up (redirecting) the F1 interface path (including F1-C and F1-U) to be between the IAB-DU and the target IAB donor CU, transferring context information for the IAB-DU from the source IAB donor CU to the target IAB donor CU, configuration of backhaul radio link control (RLC) channel, backhaul adaptation protocol (BAP) routing, and mapping rules along the target F1 path(s), release of BAP route along source path, removal of the F1 interface along the path between the IAB-DU and the source IAB donor CU, and/or any of various other tasks.

At least in some instances, the IAB node may provide co-located IAB-MT identification information to the target IAB donor CU as part of the DU migration, e.g., to inform the target IAB donor CU of the association between the IAB-MT and the IAB-DU of the migrating IAB node. The co-located IAB-MT identification information could include gNB-DU UE FIAP ID, C-RNTI for the IAB-MT, or another indication of the co-location relationship between the MT and DU BAP routing ID and path ID. The co-located IAB-MT identification information could be indicated in a new information element designated for such a purpose, which could be provided in conjunction with one or more of an F1 setup request provided from the IAB node to the target IAB donor CU, or a GNB-DU configuration update message provided from the IAB node to the target IAB donor CU, at least according to some embodiments.

In 506, the IAB node may configure handover from the source IAB donor CU to the target IAB donor CU for wireless devices attached to the IAB node, e.g., including the wireless device that established a wireless link with the IAB node. The handover may be configured and implemented in any of a variety of possible ways.

In some embodiments, the handover may be configured as a basic handover, which may be initiated before or after migration for the MT and DU of the IAB node from the source donor CU to the target donor CU are performed. In such scenarios, the source IAB donor CU may provide RRC reconfiguration information to the wireless device indicating to perform the handover. In some instances, the handover may be configured without a random access channel (RACH) procedure between the wireless device and the IAB node, or with the RACH procedure optional, e.g., since the wireless interface between the wireless device and the IAB node may not be changing for the handover. The RRC reconfiguration information may include an indication that the handover is RACH-less (and/or RACH-optional), for example in a new information element designated to provide such an indication. At least in some instances, the RRC reconfiguration information with the handover indication may be transmitted to all wireless devices associated with the DU of the IAB node, for example using a group cell radio network temporary identifier (C-RNTI). Note that the wireless device (and any other wireless devices served by the IAB-DU) may need to change key information after reception of the handover command, e.g., based on the change in association of the serving IAB-DU from the source donor CU to the target donor CU.

In case the handover is initiated before the migration for the MT and DU of the IAB node from the source donor CU to the target donor CU are performed, it may be the case that the IAB node stores the RRC reconfiguration complete response from the wireless device (and any other wireless devices served by the IAB-DU) until after the migration for the MT and DU of the IAB node is complete. Once the full IAB node migration has been performed, this RRC message from the wireless device completing the wireless device handover can be provided from the migrating IAB node to the target donor CU.

In some embodiments, the handover may be configured as a conditional handover. Similar to a basic handover, in such scenarios, the source IAB donor CU may provide RRC reconfiguration information to the wireless device to configure the handover. In some instances, the handover may be configured without a RACH procedure between the wireless device and the IAB node, or with the RACH procedure optional, e.g., since the wireless interface between the wireless device and the IAB node may not be changing for the handover. The RRC reconfiguration information may include an indication that the handover is RACH-less (and/or RACH-optional), for example in a new information element designated to provide such an indication. At least in some instances, the RRC reconfiguration information configuring the conditional handover may be transmitted to all wireless devices associated with the DU of the IAB node, for example using a group C-RNTI. At least in some instances, it may be the case that only the DU of the IAB node is included in a candidate cell list for the conditional handover (e.g., since the link between the IAB node and the wireless devices served by the IAB node does not change as part of the handover from the source donor CU to the target donor CU).

Configuring the conditional handover may include configuring one or more trigger conditions for executing the conditional handover. Since the wireless interface between the wireless device and the IAB node may not be changing for an IAB node migration-triggered handover, one or more alternative conditions to channel quality-based conditional handover trigger conditions may be used. As one such possibility, a handover notification may be configured as a conditional handover trigger condition. In such a scenario, after migration for the MT and DU of the IAB node from the source donor CU to the target donor CU are complete, the target donor CU may provide a handover notification to the IAB node (e.g., in a GNB-CU configuration update), which may in turn provide a handover notification to the wireless devices associated with its IAB-DU (e.g., by providing RRC reconfiguration information with the handover notification using a group C-RNTI). This may trigger the wireless devices to execute the conditional handover. As another possibility, one or more of physical cell identifier (PCI) change or a new radio (NR) cell global identifier (NCGI) change may be configured as a conditional handover trigger condition. In such a scenario, after migration for the MT and DU of the IAB node from the source donor CU to the target donor CU are complete, the IAB-DU may change its PCI and/or NCGI (e.g., based at least in part on having performed full migration from the source donor CU to the target donor CU). The IAB node may indicate its new PCI and/or NCGI (e.g., broadcasting system information including such information, as one possibility), and the wireless devices served by the IAB node may detect the change and trigger execution of the conditional handover.

Once the handover is triggered (e.g., based on a configured trigger condition or set of trigger conditions for conditional handover, or when a handover command is received for basic handover), the wireless device may execute the handover from the source donor CU to the target donor CU.

Thus, at least according to some embodiments, the method of FIG. 5 may be used to provide a framework according to which it may be possible to perform inter-donor full migration of mobile integrated access and backhaul nodes, and thus to assist a cellular network to effectively and efficiently manage network load, at least in some instances.

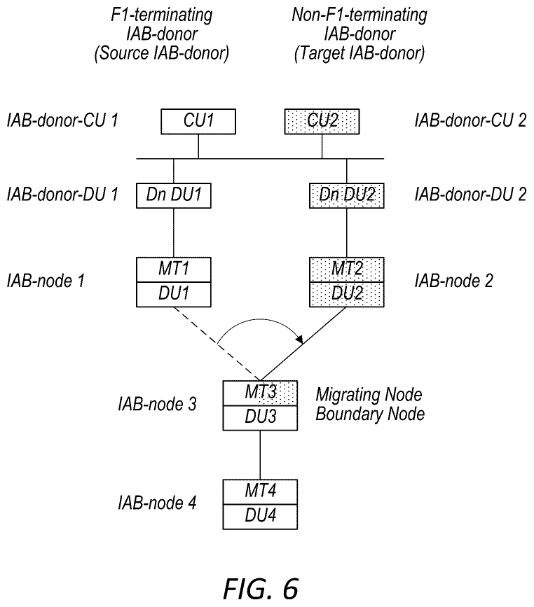

### FIGS. 6-13 and Additional Information

FIGS. 6-13 illustrate further aspects that might be used in conjunction with the method of FIG. 5 if desired. It should be noted, however, that the exemplary details illustrated in and described with respect to FIGS. 6-13 are not intended to be limiting to the disclosure as a whole: numerous variations and alternatives to the details provided herein below are possible and should be considered within the scope of the disclosure.

Integrated Access and Backhaul (IAB) nodes may utilize wireless communications for both serving UEs and performing backhaul communication with other cellular network nodes (e.g., a IAB donor node or possibly an intermediary IAB node), at least according to some embodiments. There numerous techniques and procedures that may be useful to support deployment and effective use of such nodes in a cellular communication system. One potentially useful aspect of such nodes may include the possibility for IAB node mobility, for example potentially including inter-donor migration of an entire mobile IAB node. Techniques for supporting IAB node mobility, as well as for group mobility of UEs served by such an IAB node, are accordingly described herein. Mitigation of interference due to IAB node mobility, including the avoidance of potential reference and control signal collisions (e.g., PCI, RACH), may be a consideration for these techniques. At least in some embodiments, it may be the case that a mobile IAB node does not have any descendent IAB nodes (e.g., it serves only UEs and not any other IAB nodes).

FIG. 6 illustrates aspects of a system in which inter-donor partial migration can be performed. In the illustrated scenario, the IAB mobile termination (MT) for an IAB node can migrate to a different parent node underneath another IAB-donor-centralized unit (CU). In this

case, the collocated IAB-distributed unit (DU) and the IAB-DU(s) of its descendent node(s) may retain F1 connectivity with the initial IAB-donor-CU. This migration may be referred to as inter-donor partial migration. The IAB node that performs such partial migration may be referred to as a boundary IAB node. After the inter-donor partial migration, the F1 traffic of the IAB-DU and its descendent nodes may be routed via the BAP layer of the topology to which the IAB-MT has migrated. In some embodiments, such inter-donor partial migration may be supported for 5G standalone (SA) mode. In such a partial migration scenario, the DU of the boundary node doesn't change after migration (e.g., in the illustrated scenario, IAB node 3 may still be served by IAB-donor-CU1 even after MT3 migrates from IAB node 1 to IAB node 2), so any descendent IAB nodes (e.g., IAB node 4 in the illustrated scenario) and associated UEs may not need to perform migration or handover.

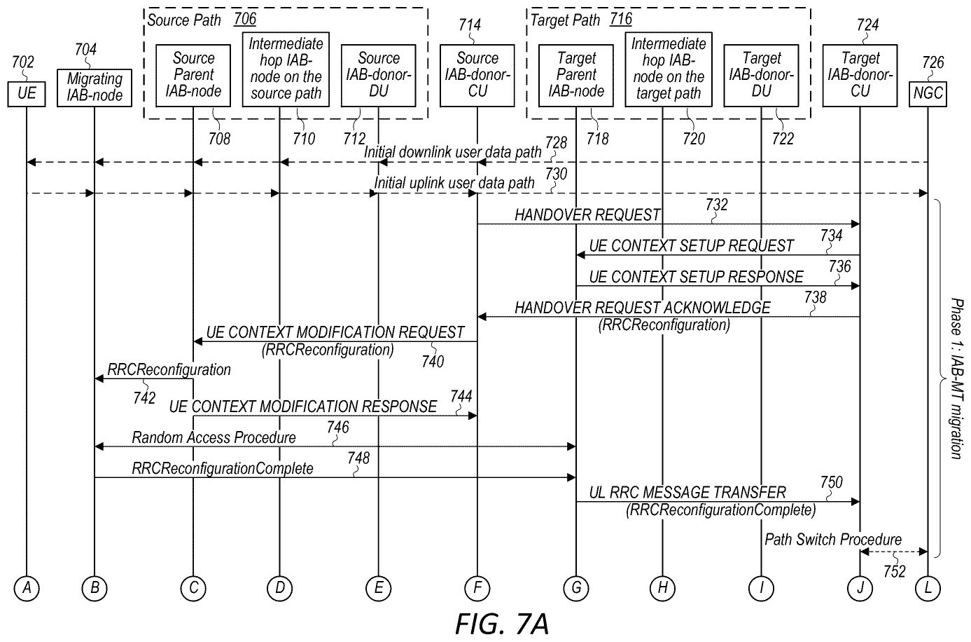

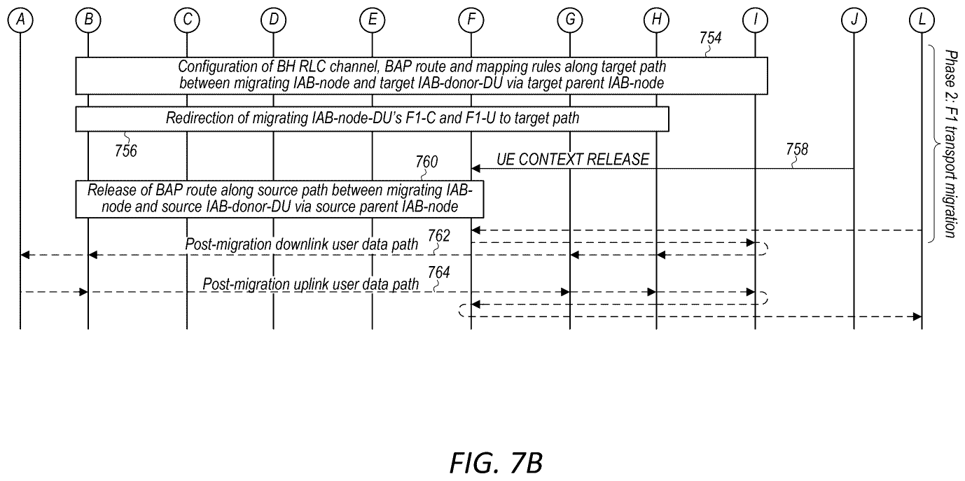

FIGS. 7A-7B illustrate a signal flow diagram showing a possible procedure for such partial migration, according to some embodiments. As shown, the procedure may be performed between a UE 702, a migrating IAB node 704, a source path 706 (which may include a source parent IAB node 708, an intermediate hop IAB node on the source path 710, and a source IAB donor DU 712), a source IAB donor CU 714, a target path 716 (which may include a target parent IAB node 718, an intermediate hop IAB node on the target path 720, and a target IAB donor DU 722), a target IAB donor CU 724, and a next generation core (NGC) network 726. Initially, the downlink user data path 728 and the uplink user data path 730 may include the NGC 726, the source IAB donor CU 714, the source path 706, the migrating IAB node 704, and the UE 702. In 732, the source IAB donor CU 714 may provide a handover request to the target IAB donor CU 724. In 734 and 736, the target IAB donor CU 724 and the target parent IAB node 718 may exchange UE context setup request and response messages. In 738, the target IAB donor CU 724 may provide a handover request acknowledge message (e.g., with RRC reconfiguration information) to the source IAB donor CU 714. In 740, the source IAB donor CU 714 may provide a UE context modification request (e.g., with RRC reconfiguration information) to the source parent IAB node 708, which may, in 742, provide RRC reconfiguration information to the migrating IAB node 704. In 744, the source parent IAB node 708 may provide a UE context modification response to the source IAB donor CU 714. In 746, the migrating IAB node 704 may perform a random access procedure with the target parent IAB node 718. In 748, the migrating IAB node 704 may indicate to the target parent IAB node 718 that RRC reconfiguration is complete. In 750, the target parent IAB node 718 may provide an uplink RRC message transfer (e.g., indicating that RRC reconfiguration is complete) to the target IAB donor CU 724. In 752, the target IAB donor CU 724 may perform a path switch procedure with the NGC 726.

In 754, the backhaul (BH) radio link control (RLC) channel, backhaul adaptation protocol (BAP) route, and mapping rules along the target path may be configured between the migrating IAB node 704 and the target IAB donor DU 722 via the target parent IAB node 718. In 756, the F1-C and F1-U for the DU of the migrating IAB node 704 may be redirected to the target path. In 758, the target IAB donor node 724 may provide a UE context release indication to the source IAB donor CU 714. In 760, the BAP route along the source path between the migrating IAB node 704 and the source IAB donor DU 714 via the source parent IAB node 706 may be released. As shown, after the partial migration procedure is complete, the post migration downlink user data path 762 and the post migration uplink user data path 764 may include the NGC 726, the source IAB donor CU 714, the target path 716, the migrating IAB node 704, and the UE 702.

Thus, the IAB-MT for the migrating IAB node may switch from an old parent node to a new parent node, where the old and new parent nodes are served by different IAB donor CUs. Xn Handover preparation procedure may serve as a baseline. In case the IAB-DU of the migrating IAB node retains its F1 connection with the source IAB donor CU after the migrating IAB-MT connects to the target IAB donor CU, this procedure may be considered to render the migrating IAB node as a boundary IAB node. Further details for some possible example partial migration procedures and details can also be found in 3GPP TS 38.401 v.17.0.0 sections 8.17.3.1 and 8.17.3.2, at least according to some embodiments.

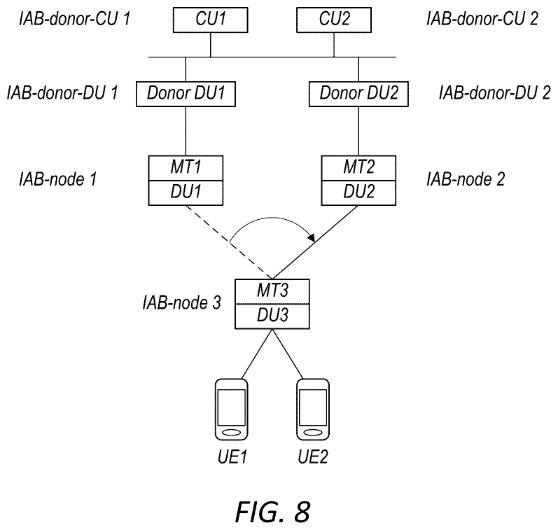

Such a procedure may be used, e.g., in combination with further procedures, to perform full migration of an IAB node. FIG. 8 illustrates aspects of a system in which inter-donor full migration can be performed. In the illustrated scenario, the IAB boundary node MT may perform partial migration (e.g., as illustrated and described with respect to FIG. 7, as one possibility). The IAB boundary node DU may also switch from the source donor CU to the target donor CU. Additionally, the IAB boundary node DU associated UEs may perform handover (e.g., from CU1 to CU2 in the illustrated scenario). According to various embodiments, it may be possible for basic or conditional handover to be performed for the associated UEs.

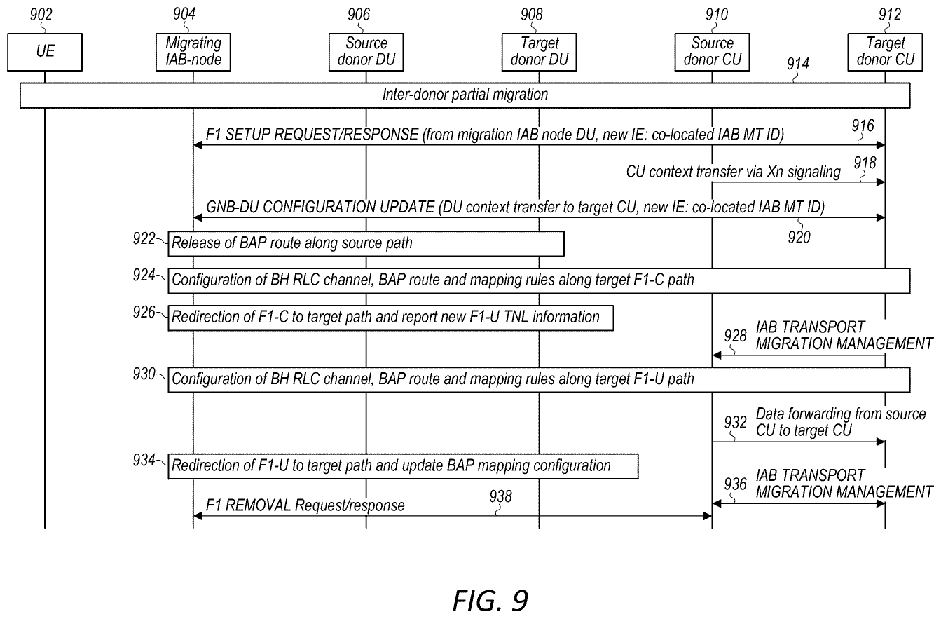

FIG. 9 is a signal flow diagram illustrating a possible procedure for performing a switch from a source donor CU to a target donor CU for a IAB boundary node DU. As shown, the procedure may be performed between a UE 902, a migrating IAB node 904, a source donor DU 906, a target donor DU 908, a source donor CU 910, and a target donor CU 912. In 914, inter-donor partial migration (e.g., such as illustrated and described with respect to FIG. 7 herein and/or as specified in Section 8.17.3.1 of 3GPP TS 38.401, among various possibilities) may be performed. In 916, the migrating IAB node 904 may perform F1 setup request/response with the target donor CU 912. The migrating IAB node DU may include a new information element with the F1 setup request to indicate the co-located IAB-MT ID, in some instances. The IAB-MT ID can be the gNB-DU UE F1 AP ID, C-RNTI, or co-location relation between MT and DU, BAP routing ID and BAP path ID, among various possibilities. In 918, CU context transfer may be performed from the source donor CU 910 to the target donor CU 912 via Xn signaling. The context transfer may include the contexts of all involved UEs, IAB-MTs, and IAB-DUs. Backhaul and topology related information (e.g., including BAP header rewriting being updated at the former boundary node) may also be included, as well as IP address information, at least according to some embodiments. In 920, the migrating IAB node 904 and the target donor CU 912 may perform GNB-DU configuration update, e.g., to transfer DU context for the target donor CU 912 to the migrating IAB mode 904 DU. A new information element indicating the co-located IAB-MT ID may be included with the GNB-DU configuration update (e.g., alternatively or in addition to including such information with the F1 setup request, according to various embodiments), in some instances. In 922, the BAP route along the source path may be released. In 924, the BH RLC channel, BAP route, and mapping rules along the target F1-C path may be configured. Note that because the target DU may already have a configured BAP route from the partial migration previously performed, the BAP configuration can be reused, with BAP header rewriting. In 926, redirection of F1-C to the target path and reporting of new F1-U TNL information may be performed. In 928, IAB transport migration management may be performed between the target donor CU 912 and the source donor CU 910. In 930, the BH RLC channel, BAP route, and mapping rules along the target F1-U path may be configured. As for the F1-C path configuration and redirection, for the F1-U path configuration and redirection, because the target DU may already have a configured BAP route from the partial migration previously performed, the BAP configuration can be reused, with BAP header rewriting. In 932, data forwarding from the source donor CU 910 to the target donor CU 912 may be performed. In 934, redirection of F1-U to the target path may be performed and the BAP mapping configuration may be updated. In 936, IAB transport migration management may be performed between the target donor CU 912 and the source donor CU 910. In 938, F1 removal may be requested and confirmed between the migrating IAB node 904 and the source donor CU 910.

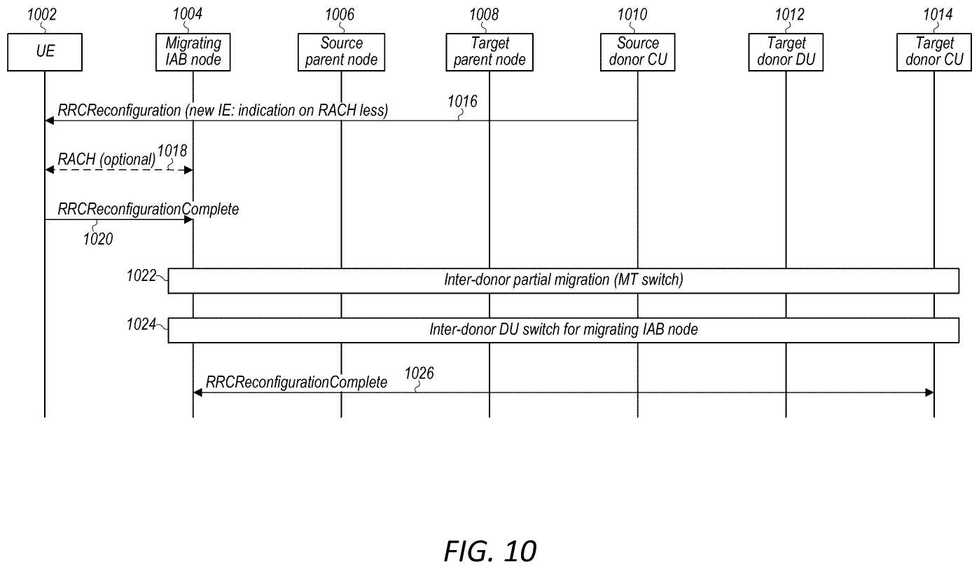

Handover of the UEs associated with a IAB-DU that is migrating may be performed in a variety of possible ways, including multiple possible variations on basic and conditional handover approaches. As one possible basic handover approach, a group handover may be initiated before the IAB node performs migration. FIG. 10 is a signal flow diagram illustrating aspects of such a possible scenario, according to some embodiments. As shown, the procedure may be performed between a UE 1002, a migrating IAB node 1004, a source parent node 1006, a target parent node 1008, a source donor CU 1010, a target donor DU 1012, and a target donor CU 1014. In 1016, the source donor CU 1010 may provide a RRC reconfiguration indication to handover all UEs associated with the migrating IAB node 1004 (e.g., including UE 1002) to perform handover to the target donor CU 1014. Note that the RRC reconfiguration indication can be broadcast to all associated UEs with a group C-RNTI, at least in some embodiments. In some instances, the handover may be performed without a random access channel (RACH) procedure, e.g., since the air interface between the UE and the migrating IAB node 1004 may not be changing. The RRC reconfiguration indication may include a new information element to indicate whether to skip a RACH procedure (e.g., to perform “RACH less” handover) with the DU of the migrating IAB node 1004. If the handover is not RACH less, or RACH is configured as optional and the UE 1002 decides to perform a RACH procedure, in 1018, the UE 1002 may perform a RACH procedure with the migrating IAB node 1004. In 1020, the UE 1002 may provide a RRC reconfiguration complete indication to the migrating IAB node 1004. The UE 1002 (as well as any other applicable UEs) may need to change keys after reception of the handover command. The RRC message may be stored by the migrating IAB node 1004 until after completion of the migration. In 1022, inter-donor partial migration (e.g., such as illustrated and described with respect to FIG. 7 herein and/or as specified in Section 8.17.3.1 of 3GPP TS 38.401, among various possibilities) may be performed. In 1024, inter-donor DU switching from the source donor CU 1010 to the target donor CU 1014 for the DU of the migrating IAB node 1004 (e.g., such as illustrated and described with respect to FIG. 9 herein, as one possibility) may be performed. In 1026, the migrating IAB node 1004 and the target donor CU 1014 may complete the RRC reconfiguration for the handover of the UE 1002 associated with the DU of the migrating IAB node 1004.

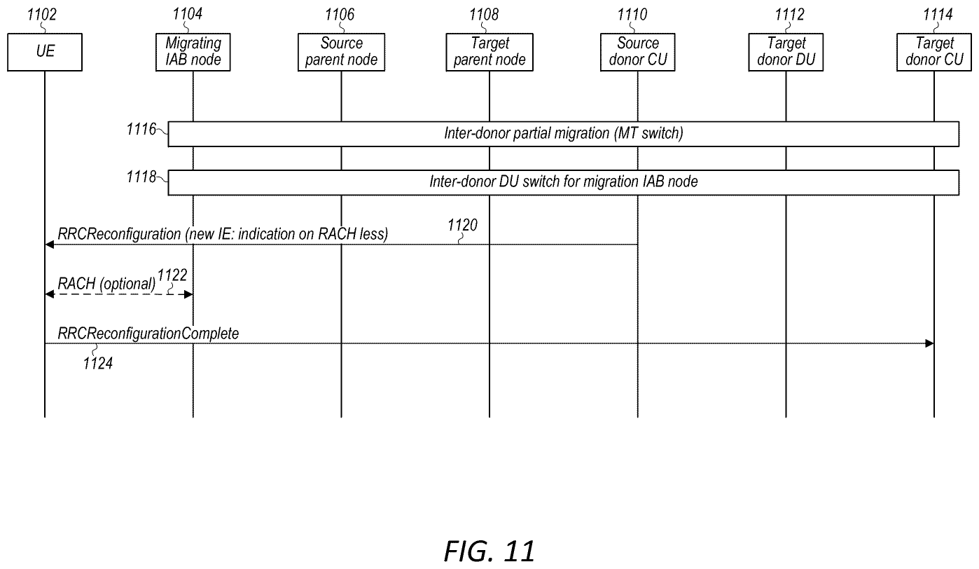

As another possible basic handover approach, a group handover may be initiated after the IAB node performs migration. FIG. 11 is a signal flow diagram illustrating aspects of such a possible scenario, according to some embodiments. As shown, the procedure may be performed between a UE 1102, a migrating IAB node 1104, a source parent node 1106, a target parent node 1108, a source donor CU 1110, a target donor DU 1112, and a target donor CU 1114. In 1116, inter-donor partial migration (e.g., such as illustrated and described with respect to FIG. 7 herein and/or as specified in Section 8.17.3.1 of 3GPP TS 38.401, among various possibilities) may be performed. In 1118, inter-donor DU switching from the source donor CU 1110 to the target donor CU 1114 for the DU of the migrating IAB node 1104 (e.g., such as illustrated and described with respect to FIG. 9 herein, as one possibility) may be performed. In 1120, the source donor CU 1110 may provide a RRC reconfiguration indication to handover all UEs associated with the migrating IAB node 1104 (e.g., including UE 1102) to perform handover to the target donor CU 1114. Similar to the scenario of FIG. 10, in the scenario of FIG. 11 the RRC reconfiguration indication can be broadcast to all associated UEs with a group C-RNTI. In some instances, the handover may be performed without a random access channel (RACH) procedure, e.g., since the air interface between the UE and the migrating IAB node 1104 may not be changing. The RRC reconfiguration indication may include a new information element to indicate whether to skip a RACH procedure (e.g., to perform “RACH less” handover) with the DU of the migrating IAB node 1104. If the handover is not RACH less, or RACH is configured as optional and the UE 1102 decides to perform a RACH procedure, in 1122, the UE 1102 may perform a RACH procedure with the migrating IAB node 1104. In 1124, the UE 1102 may provide a RRC reconfiguration complete indication to the target donor CU 1114, via the migrating IAB node 1004 and through the new target CU route, to complete the RRC reconfiguration for the handover of the UE 1102 associated with the DU of the migrating IAB node 1104. The UE 1102 (as well as any other applicable UEs) may need to change keys after reception of the handover command.

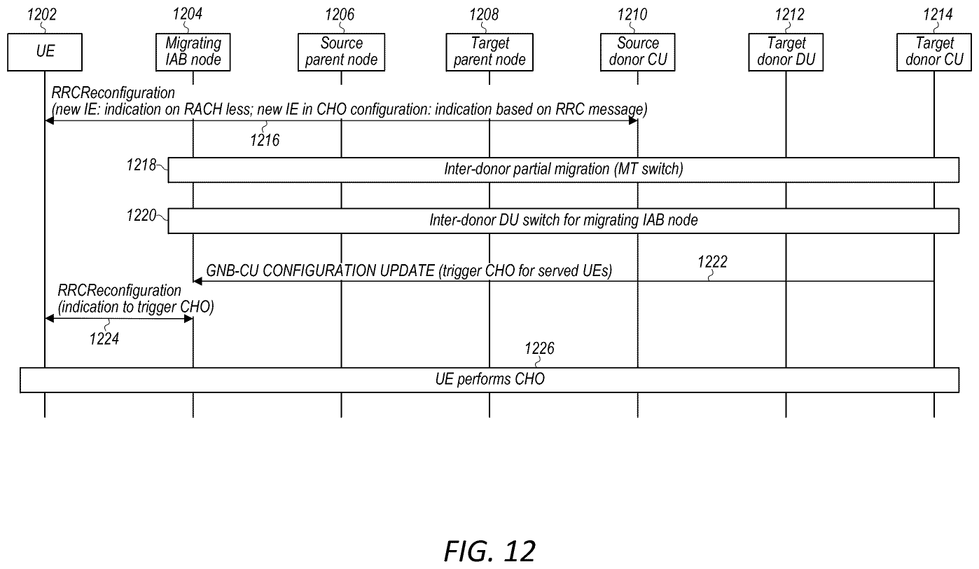

For conditional handover-based approaches, since the UE may still be served by the same IAB node DU after migration, channel quality based conditional handover (CHO) conditions (e.g., A3 and A5 events) may not be applicable trigger conditions. Accordingly, as one possibility, a new CHO condition can be configured, such as transmission of a (e.g., broadcast) trigger indication. For example, upon completion of full migration of a migrating IAB node, the new CU can send a notification message to the migrating IAB node DU via F1 signaling, and the migrating IAB node DU may include a conditional handover trigger indication in a RRC reconfiguration message to all served UEs. Upon reception of the indication, each such UE may start to execute the conditional handover. FIG. 12 is a signal flow diagram illustrating aspects of such a possible scenario, according to some embodiments. As shown, the procedure may be performed between a UE 1202, a migrating IAB node 1204, a source parent node 1206, a target parent node 1208, a source donor CU 1210, a target donor DU 1212, and a target donor CU 1214. In 1216, the source donor CU 1210 may provide RRC reconfiguration information to the UE 1202 configuring conditional handover. The information may include an indication of whether the handover is RACH less, and/or an indication in CHO configuration information that the CHO can be triggered by a RRC message-based indication. In 1218, inter-donor partial migration (e.g., such as illustrated and described with respect to FIG. 7 herein and/or as specified in Section 8.17.3.1 of 3GPP TS 38.401, among various possibilities) may be performed. In 1220, inter-donor DU switching from the source donor CU 1210 to the target donor CU 1214 for the DU of the migrating IAB node 1204 (e.g., such as illustrated and described with respect to FIG. 9 herein, as one possibility) may be performed. In 1222, the target donor CU 1214 may provide GNB-CU configuration update information to the migrating IAB node 1204 indicating to trigger CHO for the served UEs. In 1224, the migrating IAB node 1204 may provide RRC reconfiguration information with the indication to trigger CHO to the UE 1202 (e.g., and any other applicable UEs). In 1226, the UE 1202 (e.g., and any other applicable UEs) may execute the configured and triggered conditional handover.

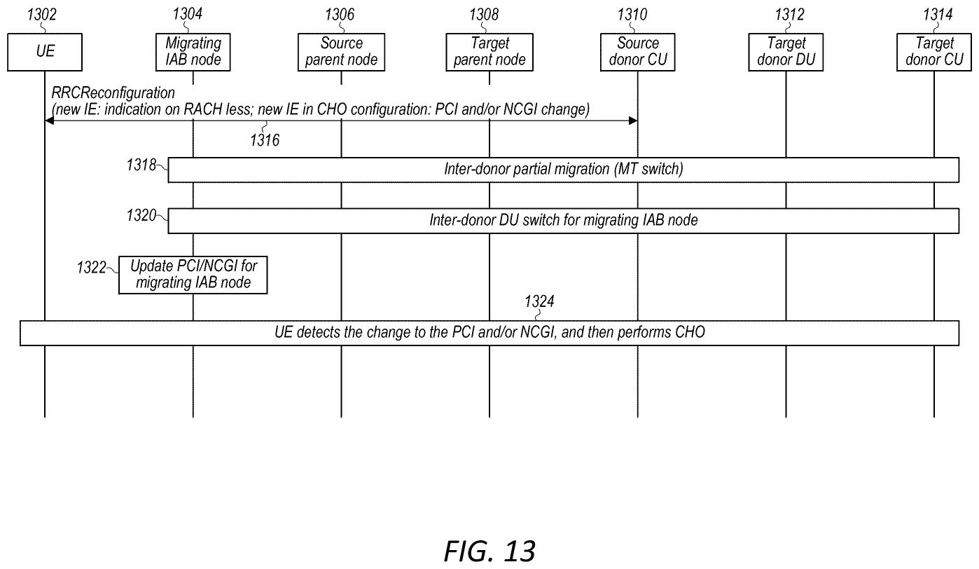

As another possibility, it may be possible that physical cell identifier (PCI) or NR cell global identifier (NCGI) change triggered CHO can be configured. For example, upon completion of the DU switch for a IAB node performing full migration, the PCI and NCGI of the DU may be changed. Detection of this change of PCI and/or NCGI may accordingly be used to trigger execution of a conditional handover. FIG. 13 is a signal flow diagram illustrating aspects of such a possible scenario, according to some embodiments. As shown, the procedure may be performed between a UE 1302, a migrating IAB node 1304, a source parent node 1306, a target parent node 1308, a source donor CU 1310, a target donor DU 1312, and a target donor CU 1314. In 1316, the source donor CU 1310 may provide RRC reconfiguration information to the UE 1302 configuring conditional handover. The information may include an indication of whether the handover is RACH less, and/or an indication in CHO configuration information that the CHO can be triggered by a PCI and/or NCGI change. In 1318, inter-donor partial migration (e.g., such as illustrated and described with respect to FIG. 7 herein and/or as specified in Section 8.17.3.1 of 3GPP TS 38.401, among various possibilities) may be performed. In 1320, inter-donor DU switching from the source donor CU 1310 to the target donor CU 1314 for the DU of the migrating IAB node 1304 (e.g., such as illustrated and described with respect to FIG. 9 herein, as one possibility) may be performed. In 1322, the migrating IAB node 1304 may update its PCI and/or NCGI. In 1324, the UE 1302 (e.g., and any other applicable UEs) may detect the change to the PCI and/or NCGI, which may trigger execution of the conditional handover.

Note that because the IAB node DU may not be expected to be changed, it may be the case that only the source DU is included in the candidate cell list for the conditional handover. For a UE that does not support such conditional handover in conjunction with full migration of a serving IAB node, it may be possible that the serving CU can send a basic handover command to such a UE (e.g., CHO may not be applied to such UEs), or it may be the case that no special handling is provided for such UEs. In the latter scenario, it may be possible that such UEs would detect RLF due to RLC, at least according to some embodiments.

In the following further exemplary embodiments are provided.

One set of embodiments may include a method, comprising: by an integrated access and backhaul (IAB) node: performing migration for a mobile termination (MT) of the IAB node from a source donor centralized unit (CU) to a target donor CU; performing migration for a distributed unit (DU) of the IAB node from the source donor CU to the target donor CU; and configuring handover from the source donor CU to the target donor CU for one or more wireless devices served by the DU of the IAB node.

According to some embodiments, performing migration for the DU of the IAB node from the source donor CU to the target donor CU further includes providing co-located IAB-MT identification information to the target donor CU.

According to some embodiments, the co-located IAB-MT identification information is provided in one of: a Fl setup request provided to the target donor CU; or a GNB-DU configuration update message provided to the target donor CU.

According to some embodiments, performing migration for the DU of the IAB node from the source donor CU to the target donor CU further includes: configuring backhaul radio link control channel, backhaul adaptation protocol (BAP) route, and mapping rules for a F1-C interface path and for a F1-U interface path for the target donor CU; and releasing BAP route and requesting F1 interface removal for the source donor CU.

According to some embodiments, the handover from the source donor CU to the target donor CU is initiated before migration for the MT and DU of the IAB node from the source donor CU to the target donor CU are performed.

According to some embodiments, the handover from the source donor CU to the target donor CU is initiated after migration for the MT and DU of the IAB node from the source donor CU to the target donor CU are performed.

According to some embodiments, the handover from the source donor CU to the target donor CU is configured as a conditional handover, wherein a handover triggering condition for the conditional handover includes a handover notification, wherein the method further comprises, after migration for the MT and DU of the IAB node from the source donor CU to the target donor CU are complete: receiving the handover notification from the target donor CU; and providing the handover notification to all wireless devices associated with the DU of the IAB node.

According to some embodiments, the handover from the source donor CU to the target donor CU is configured as a conditional handover, wherein a handover triggering condition for the conditional handover includes one or more of physical cell identifier (PCI) change or a new radio (NR) cell global identifier (NCGI) change, wherein the method further comprises: changing the PCI and NCGI of the DU of the IAB node based at least in part on performing migration for the MT and DU of the IAB node from the source donor CU to the target donor CU.

According to some embodiments, only the DU of the IAB node is included in a candidate cell list for the conditional handover.

According to some embodiments, the handover from the source donor CU to the target donor CU is initiated by transmitting radio resource control (RRC) reconfiguration information to all wireless devices associated with the DU of the IAB node using a group cell radio network temporary identifier (C-RNTI).

According to some embodiments, the RRC reconfiguration information initiating the handover from the source donor CU to the target donor CU indicates to perform the handover in a random access channel (RACH)-less manner.

Another set of embodiments may include a cellular base station, comprising: one or more processors; and a memory having instructions stored thereon, which when executed by the one or more processors, perform steps of the method of any of the preceding examples.

Still another set of embodiments may include a method, comprising: by a wireless device: establishing a wireless link with a cell provided by an integrated access and backhaul (IAB) node; receiving information configuring handover from a source donor centralized unit (CU) to a target donor CU, wherein a distributed unit (DU) of the IAB node is both a source DU and a target DU for the handover; and performing handover from the source donor CU to the target donor CU.

According to some embodiments, the information configuring handover from the source donor CU to the target donor CU indicates to perform the handover without performing a random access channel (RACH) procedure.

According to some embodiments, the information configuring handover from the source donor CU to the target donor CU is received using a group cell radio network temporary identifier (C-RNTI).

According to some embodiments, handover from the source donor CU to the target donor CU is configured as a conditional handover, wherein the information configuring handover from the source donor CU to the target donor CU further includes an indication of one or more handover triggering conditions for the conditional handover.

According to some embodiments, the one or more handover triggering conditions for the conditional handover include a handover notification, wherein the method further comprises: receiving the handover notification from the IAB node; and executing the conditional handover based at least in part on receiving the handover notification from the IAB node.

According to some embodiments, the one or more handover triggering conditions for the conditional handover include one or more of physical cell identifier (PCI) change or a new radio (NR) cell global identifier (NCGI) change, wherein the method further comprises: receiving system information from the IAB node, wherein the system information indicates one or more of a PCI or a NCGI for the IAB node; determining that one or more of a PCI change or a NCGI change has occurred; and executing the conditional handover based at least in part on determining that one or more of a PCI change or a NCGI change has occurred.

Still another set of embodiments may include a wireless device, comprising: one or more processors; and a memory having instructions stored thereon, which when executed by the one or more processors, perform steps of the method of any of the preceding examples.

A still further set of embodiments may include a computer program product, comprising computer instructions which, when executed by one or more processors, perform steps of the method of any of the preceding examples.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
performing migration for a mobile termination (MT) of an integrated access and backhaul (IAB) node from a source donor centralized unit (CU) to a target donor CU;
performing migration for a distributed unit (DU) of the IAB node from the source donor CU to the target donor CU; and
configuring handover from the source donor CU to the target donor CU for one or more wireless devices served by the DU of the IAB node.

2. The method of claim 1,
wherein performing migration for the DU of the IAB node from the source donor CU to the target donor CU further includes providing co-located IAB-MT identification information to the target donor CU.

3. The method of claim 2,
wherein the co-located IAB-MT identification information is provided in one of:
a F1 setup request provided to the target donor CU; or
a GNB-DU configuration update message provided to the target donor CU.

4. The method of claim 1,
wherein performing migration for the DU of the IAB node from the source donor CU to the target donor CU further includes:
configuring backhaul radio link control channel, backhaul adaptation protocol (BAP) route, and mapping rules for a F1-C interface path and for a F1-U interface path for the target donor CU; and
releasing BAP route and requesting F1 interface removal for the source donor CU.

5. The method of claim 1,
wherein the handover from the source donor CU to the target donor CU is initiated before migration for the MT and DU of the IAB node from the source donor CU to the target donor CU are performed.

6. The method of claim 1,
wherein the handover from the source donor CU to the target donor CU is initiated after migration for the MT and DU of the IAB node from the source donor CU to the target donor CU are performed.

7. The method of claim 1,
wherein the handover from the source donor CU to the target donor CU is configured as a conditional handover, wherein a handover triggering condition for the conditional handover includes a handover notification, wherein the method further comprises, after migration for the MT and DU of the IAB node from the source donor CU to the target donor CU are complete:
receiving the handover notification from the target donor CU; and
providing the handover notification to all wireless devices associated with the DU of the IAB node.

8. The method of claim 1,
wherein the handover from the source donor CU to the target donor CU is configured as a conditional handover, wherein a handover triggering condition for the conditional handover includes one or more of physical cell identifier (PCI) change or a new radio (NR) cell global identifier (NCGI) change, wherein the method further comprises:
changing the PCI and NCGI of the DU of the IAB node based at least in part on performing migration for the MT and DU of the IAB node from the source donor CU to the target donor CU.

9. The method of claim 8,
wherein only the DU of the IAB node is included in a candidate cell list for the conditional handover.

10. The method of claim 1,
wherein the handover from the source donor CU to the target donor CU is initiated by transmitting radio resource control (RRC) reconfiguration information to all wireless devices associated with the DU of the IAB node using a group cell radio network temporary identifier (C-RNTI).

11. The method of claim 10,
wherein the RRC reconfiguration information initiating the handover from the source donor CU to the target donor CU indicates to perform the handover in a random access channel (RACH)-less manner.

12. (canceled).

13. A method, comprising:
establishing a wireless link with a cell provided by an integrated access and backhaul (IAB) node;
receiving information configuring handover from a source donor centralized unit (CU) to a target donor CU, wherein a distributed unit (DU) of the IAB node is both a source DU and a target DU for the handover; and
performing handover from the source donor CU to the target donor CU.

14. The method of claim 13,
wherein the information configuring handover from the source donor CU to the target donor CU indicates to perform the handover without performing a random access channel (RACH) procedure.

15. The method of claim 13,
wherein the information configuring handover from the source donor CU to the target donor CU is received using a group cell radio network temporary identifier (C-RNTI).

16. The method of claim 13,
wherein handover from the source donor CU to the target donor CU is configured as a conditional handover, wherein the information configuring handover from the source donor CU to the target donor CU further includes an indication of one or more handover triggering conditions for the conditional handover.

17. The method of claim 16,
wherein the one or more handover triggering conditions for the conditional handover include a handover notification, wherein the method further comprises:
receiving the handover notification from the IAB node; and
executing the conditional handover based at least in part on receiving the handover notification from the IAB node.

18. The method of claim 16,
wherein the one or more handover triggering conditions for the conditional handover include one or more of physical cell identifier (PCI) change or a new radio (NR) cell global identifier (NCGI) change, wherein the method further comprises:
receiving system information from the IAB node, wherein the system information indicates one or more of a PCI or a NCGI for the IAB node;
determining that one or more of a PCI change or a NCGI change has occurred; and
executing the conditional handover based at least in part on determining that one or more of a PCI change or a NCGI change has occurred.

19-20. (canceled)

21. An apparatus, comprising:
a processor configured to, when executing instructions stored in a memory, perform operations comprising:
performing migration for a mobile termination (MT) of an integrated access and backhaul (IAB) node from a source donor centralized unit (CU) to a target donor CU;
performing migration for a distributed unit (DU) of the IAB node from the source donor CU to the target donor CU; and
configuring handover from the source donor CU to the target donor CU for one or more wireless devices served by the DU of the IAB node.

22. The apparatus of claim 21,
wherein performing migration for the DU of the IAB node from the source donor CU to the target donor CU further includes providing co-located IAB-MT identification information to the target donor CU.

23. The apparatus of claim 22,
wherein the co-located IAB-MT identification information is provided in one of:
a F1 setup request provided to the target donor CU; or
a GNB-DU configuration update message provided to the target donor CU.
